(19) United States
(12) Patent Application Publication
(10) Pub. No.: US 2007/0092169 A1
(43) Pub. Date: Apr. 26, 2007

(54) METHOD OF PROVIDING A CONSISTENT PRELOAD ON THRUST BEARINGS IN A BEARING ASSEMBLY

(76) Inventor: Orren S. Johnson, Edmonton (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/551,669

(22) Filed: Oct. 20, 2006

(30) Foreign Application Priority Data
Oct. 25, 2005 (CA) 2,522,374

(51) Int. Cl. F16C 3/00

(52) U.S. Cl. 384/97

(57) ABSTRACT

A method of providing a consistent preload on thrust bearings in a bearing assembly. A first step involves placing against an inner race and an outer race of a bearing stack of tlirust bearings, deformable shims made from a material having a relatively flat stress-strain curve after its yield stress has been exceeded. A second step involves preloading the deformable shims beyond their yield point in situ until a predetermined preload tolerance is reached.

### FIELD OF THE INVENTION

The present invention relates to a method of providing a consistent preload on thrust bearings in a bearing assembly, and a down hole bearing assembly constructed in accordance with the teachings of the method.

### BACKGROUND OF THE INVENTION

A common problem with bearing assemblies is having a consistent preload force on the inner and outer bearing races of thrust bearings. If the bearing preload is not consistent, the outer races will deform more or less than the inner bearing races. This results in non-uniform load distribution which, in turn, results in lower load handling and lift capacity of the thrust bearings. Down hole drilling fluid lubricated bearing assemblies rely upon accurate measurements being made by service technicians. If they make an error in measurement of only a few thousands of an inch, the change in the preload on the bearing stack can change significantly.

### SUMMARY OF THE INVENTION

According to the present invention there is provided a method of providing a consistent preload on thrust bearings in a bearing assembly. A first step involves placing against an inner race and an outer race of a bearing stack of thrust bearings, deformable shims made from a material having a relatively flat stress-strain curve after its yield stress has been exceeded. A second step involves preloading the deformable shims beyond their yield point in situ until a predetermined preload tolerance is reached.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a side elevation view, in section, of a down hole bearing assembly constructed in accordance with the teachings of the present invention.

FIG. 2 is a detailed side elevation view, in section, of a portion of the down hole bearing assembly illustrated in FIG. 1, showing deformable shims.

FIG. 3 is a detailed side elevation view, in section, of a portion of the down hole bearing assembly illustrated in FIG. 1, showing a mandrel jacking section.

FIG. 4 is a detailed side elevation view, in section, of a portion of the down hole bearing assembly illustrated in FIG. 1, showing a deformable overload protection ring.

FIG. 5 is a side elevation view, in section, of the down hole bearing assembly, with the housing jacking section engaged.

FIG. 6 is a side elevation view, in section, of the down hole bearing assembly illustrated in FIG. 1, with the housing removed.

### DETAILED DESCRIPTION OF THE PREFERRED EMBODIMENT

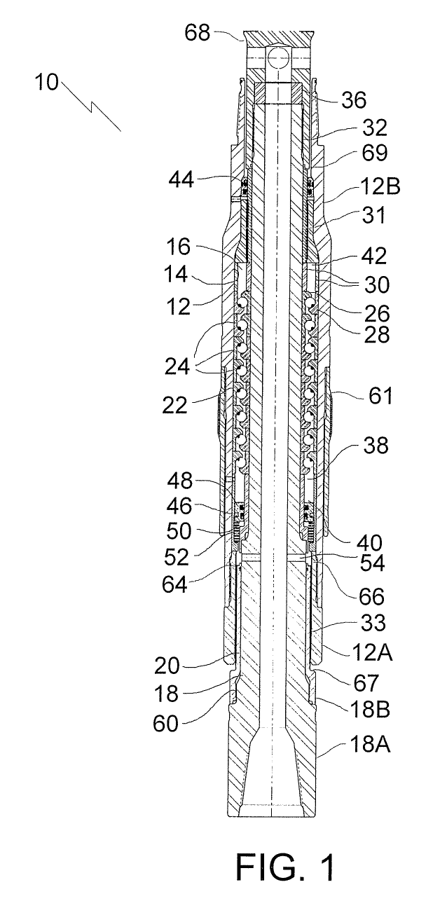

The preferred embodiment, a down hole bearing assembly generally identified by reference numeral 10, will now be described with reference to FIG. 1 through 6. There are several aspects of the present invention that will hereinafter be described.

Deformable Shims

Structure and Relationship of Parts:

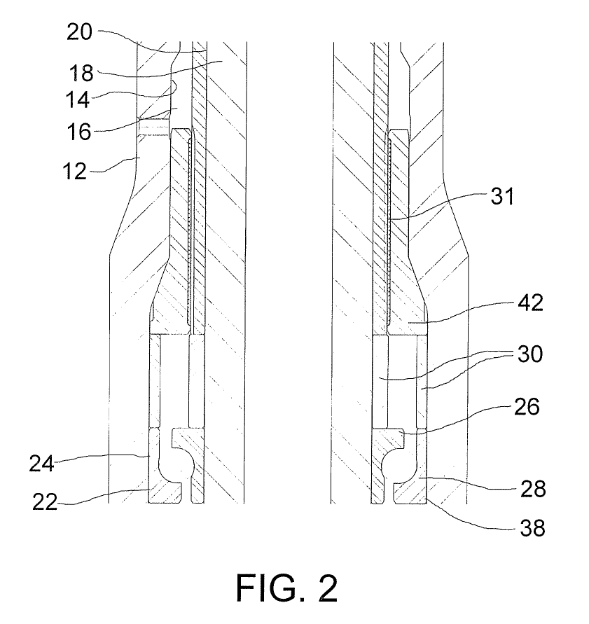

Referring now to FIG. 1, down hole bearing assembly 10 includes an outer housing 12 with an inner surface 14 defining an interior bore 16. An inner mandrel 18 is supported for rotation within interior bore 16 of outer housing 12. Inner mandrel 18 has an outer surface 20. A bearing stack 22 of thrust or radial bearings 24 is positioned between inner surface 14 of outer housing 12 and outer surface 20 of inner mandrel 18, where each thrust bearing 24 has an inner race 26 and an outer race 28. Referring to FIG. 2, deformable shims 30 are positioned against inner race 26 and outer race 28 of at least one of the thrust bearings 24 in bearing stack 22. Deformable shims 30 are made from a material, such as a soft steel or other metal material, that has a relatively flat stress-strain curve after its yield stress has been exceeded, and are preloaded beyond their yield point in situ to a predetermined preload tolerance. Bushings 31 above bearing stack 22 and bushings 33 below bearing stack 22 facilitate rotation of inner mandrel 18 with respect to outer housing 12.

Operation:

Referring to FIG. 2, down hole bearing assembly 10 is provided as described above, with shims 30 positioned against inner race 26 and outer race 28 of one of the thrust bearings 24 in bearing stack 22. Shims 30 are then loaded beyond their yield point, such that they are more deformable with additional loading. For example, Graphs 1 and 2 below show the stress-strain curve for two different alloys. In Graph 1, the yield point of the alloy is just under 600 MPa, while in Graph 2, the yield point of the alloy is just over 300 MPa. After these points, it can be seen that the alloys defonn more easily with increased pressure, and in a relatively constant mauler. This creates a very consistent and repeatable preload force to help ensure a uniform load distribution to prolong the life capacity of thrust bearings 24. For example, referring to Graph 1, if a shim is used that is 1″ long and made from UNS31803 alloy, a preload deformation of 0.1″ would result from 780 MPa of pressure, and a preload deformation of 0.3″ would result in a preload stress of less than 800 MPa, the net difference being 20 MPa. This provides a preload force that is substantially the same over a large tolerance of preload deformation. Graph 1 is an example used solely for the purposes of illustration. Other suitable materials will have a similar profile, but will exhibit the profile at different values. v,1/2 v,2/2

Torque Overload Protection

Structure and Relationship of Parts:

Referring to FIG. 4, inner mandrel 18 also has a threaded motor connection 32 adapted for threaded connection to a down hole motor assembly (not shown), and includes a U-joint 68 that connects to the power section of the down hole motor. A deformable overload protection ling 36 is included in the make up of motor connection 32, where deformable overload protection ring 36 is made from a material that has a predictable yield strength that is lower than that of inner mandrel 18, such that deformable overload protection ring 36 defonns to buffer inner mandrel 18 when momentary overload torque is transmitted through motor connection 32. In the illustrated embodiment, overload will also result in deformation of shims 30. It will be appreciated that deformable shims 30 are not essential to the operation of this aspect of the invention.

Operation:

Down hole bearing assembly 10 is provided as described above and depicted in FIG. 1, with deformable overload protection ring 36 positioned below motor connection 32. Ring 36 is made of a metal that has a predictable yield strength which is lower than the bearing mandrel or bottom adapter. This ring is intended to permanently deform when momentary overload torque is transmitted through the drill bit and motor assembly.

Low Positive Oil Pressure Innovation

Structure and Relationship of Parts:

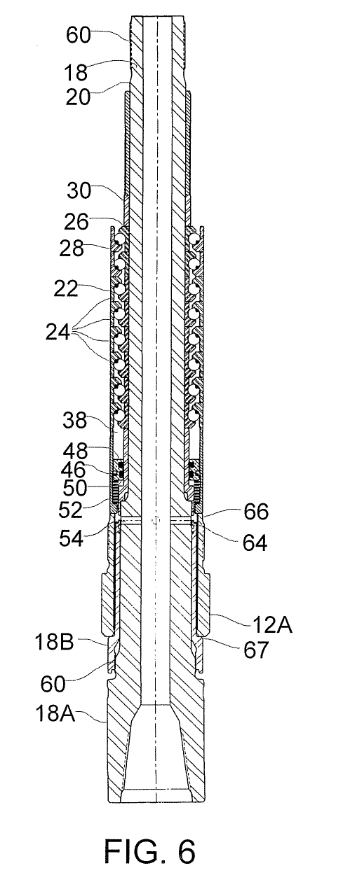

Referring to FIG. 1, a sealed and lubricant filled bearing chamber 38 is formed between inner surface 14 of outer housing 12 and outer surface 20 of inner mandrel 18. Bearing chamber 38 has a first end 40 and a second end 42 with a stationary seal 44 positioned at second end 42 and a floating seal piston 46 at first end 40, although more than one seal 44 may be used. Referring to FIG. 6, floating seal piston 46 has a lubrication face 48 acting against lubricant in bearing chamber 38 and a drilling fluid face 50 against which drilling fluid acts, and a preload spring 52 is provided which acts against drilling fluid face 50. A flow port 54 is positioned upstream of drilling fluid face 50 of floating seal piston 46, such that drilling fluid passes through flow port 54 and applies pressure to act against drilling fluid face 50 of floating seal piston 46. Bearing stack 22 of thrust bearings 24 is positioned in bearing chamber 38.

Operation:

Referring to FIG. 1, down hole bearing assembly 10 is provided as described above, with floating seal piston 46 positioned at first end of bearing chamber 38. Referring to FIG. 6, drilling fluid flows through flow port 54 and acts against drilling fluid face 50 of floating seal piston 46, with spring 52 acting against drilling fluid face 50 as well. The force due to spring 52 and drilling fluid pressure acting against drilling fluid face 50 causes lubrication face 48 to push against the lubricant within bearing chamber 38 to induce a positive pressure on the lubricant. Since spring 52 applies a force even in the absence of drilling fluid pressure, the change in pressure when the drilling fluid does apply pressure allows the lubricant to be under a greater pressure than the drilling fluid pressure in a variety of operating conditions. For example, if drilling fluid pressure at motor collection 32 is 500 psi and decreases to 470 psi at drilling fluid port 54, there would be a pressure differential of 30 psi between the two. If, however, the force applied by spring 52 increases lubricant pressure by 40 psi, then the pressure on the lubricant 510 psi, or 10 psi greater than the highest drilling fluid pressure of 500 psi.

Servicing Enhancements

Structure and Relationship of Parts:

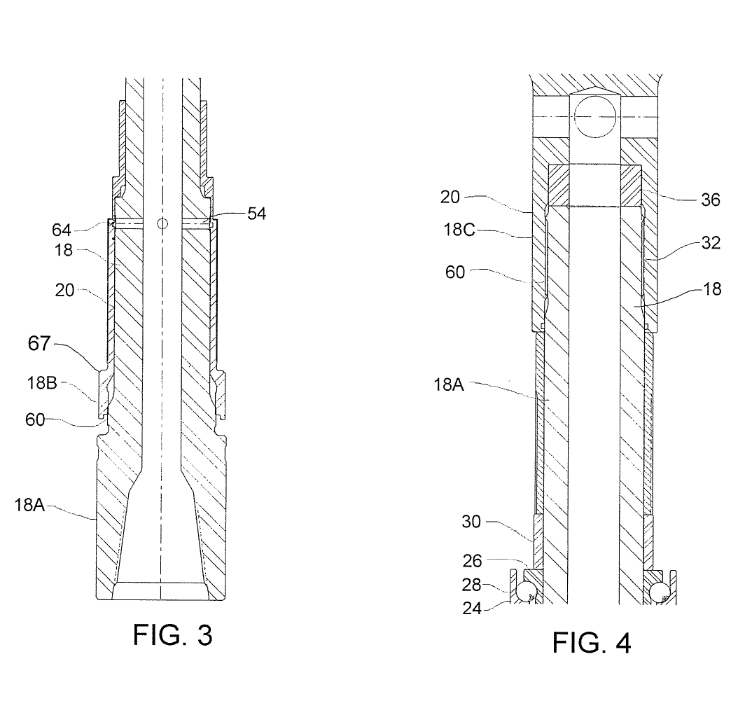

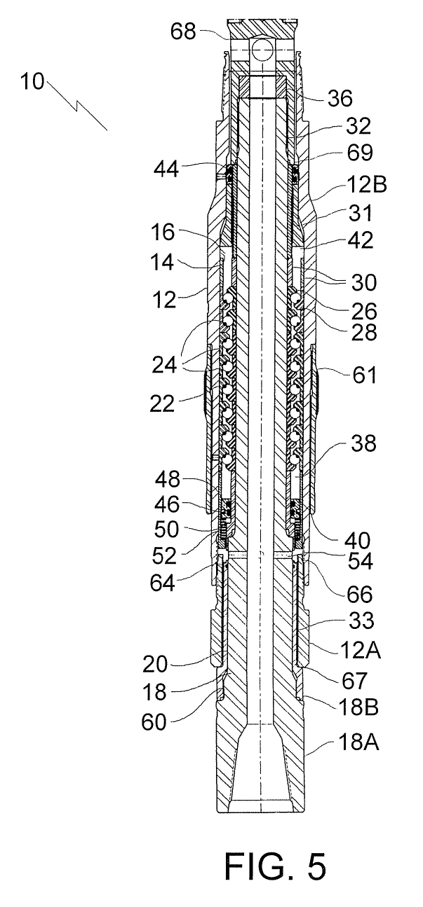

Referring now to FIG. 5, inner mandrel 18 is made in sections 1 8A and 18B, each with mating threads 60 for ease of assembly. Referring to FIG. 3, section 18A acts as a mandrel jacking section, and has a shoulder 64 that engages those components that are positioned along outer surface 20 of inner mandrel 18. Referring to FIG. 5, outer housing 12 is also made in sections 12A and 12B, with a stabilizer 61 positioned over section 12B. Section 12A acts as a housing jacking section with shoulder 66. During the housing jacking process, section 12A is backed onto shoulder 67, such that, upon rotation of section 12B, shoulder 69 applies a force to and helps loosen components that are stuck to inner surface 14 of housing 12. Shoulder 66 is used during the mandrel jacking process to apply a force against the components stuck to section 18A as section 18B, and hence section 12A, is rotated. While shoulder 66 is on section 12A, it may equally be on section 18B. The important aspect is that the movement of section 18B engages shoulder 66 and the stuck components.

Operation:

Referring to FIG. 3 and 6, down hole bearing assembly 10 is provided as described above, with sections 18A and 18B making up inner mandrel 18. Refining to FIG. 3, section 18A has a shoulder 64 that engages components along outer surface 20 of inner mandrel 18. During disassembly, mating threads 60 for mandrel jacking section 18A and 18B have sufficient travel such that mandrel jacking section 1 8A serves as a screw jack to exert a jacking force upon those components that have become stuck to outer surface 20 of inner mandrel 18. Referring to FIG. 5, mandrel jacking section 12A serves as a screw jack to exert a jacking force upon those components that have become stuck to inner surface 14 of outer housing 12. As section 12B is rotated relative to section 12A, section 12A is pushed against shoulder 67 of section 18B, which prevents further movement in that direction. Upon further rotation, shoulder 69 applies a force to those components which may be stuck on inner surface 14 of outer housing 12B to allow section 12B to be removed. Refining to FIG. 6, once section 12B has been removed, the mandrel jacking process can be used. Section 18B and therefore section 12A as well is rotated such that shoulder 66 contacts the components stuck on inner mandrel 18. This results in a tensile force along mandrel section 18A between threads 60 and shoulder 66, and a force against the components to help in disassembly.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the claims.

What is claimed is:

1. A method of providing a consistent preload on thrust beatings in a bearing assembly, comprising the steps of:
placing against an inner race and an outer race of a bearing stack of thrust bearings, deformable shims made from a material having a relatively flat stress-strain curve after its yield stress has been exceeded; and
preloading the deformable shims beyond their yield point in situ until a predetermined preload deformation range is reached.

2. The method as defined in claim 1, the deformable shims being made from a soft metal material.

3. The method as defined in claim 1, the bearing assembly having an outer housing with an inner surface defining an interior bore, an inner mandrel supported for rotation within the interior bore of the outer housing, the inner mandrel having an outer surface, the bearing stack being positioned between the inner surface of the outer housing and the outer surface of the inner mandrel.

4. A down hole bearing assembly, comprising:
an outer housing with an inner surface defining an interior bore;
an inner mandrel supported for rotation within the interior bore of the outer housing, the inner mandrel having an outer surface;
a bearing stack of thrust bearings positioned between the inner surface of the outer housing and the outer surface of the inner mandrel, each of the thrust bearings having an inner race and an outer race;
deformable shims positioned against the inner race and the outer race of at least one of the thrust bearings in the bearing stack, the deformable shims being made from a material having a relatively flat stress-strain curve after its yield stress has been exceeded, the deformable shims being preloaded beyond their yield point in situ to a predetermined preload tolerance.

5. The down hole bearing assembly as defined in claim 4, wherein the deformable shims are made from a soft metal material.

6. The down hole bearing assembly as defined in claim 4, wherein the bearing stack is disposed in a sealed and lubricant filled bearing chamber formed between the inner surface of the outer housing and the outer surface of the inner mandrel, the bearing chamber having a first end and a second end, a stationary seal being positioned at the second end, a floating seal piston at the first end, the floating seal piston having a lubrication face acting against lubricant in the bearing chamber and a drilling fluid face against which drilling fluid acts, a preload spring being provided which acts against the drilling fluid face.

7. The down hole bearing assembly as defined in claim 6, wherein a flow port is positioned upstream of the drilling fluid face of the floating seal piston, such that drilling fluid must pass through the flow port prior to acting against the drilling fluid face of the floating seal piston.

8. The down hole bearing assembly as defined in claim 4, wherein the outer housing is made in several sections with mating threads for ease of assembly, the sections serving as a housing jacking section having a first shoulder that engages a first engagement shoulder of the mandrel at the first end and a second engagement shoulder that engages components positioned along the inner surface of the outer housing a the second end, the mating threads for the housing jacking section having sufficient travel that the housing jacking section exerts a jacking force upon components which have become stuck to the inner surface of the outer housing.

9. The down hole bearing assembly as defined in claim 4, wherein the inner mandrel is made in several sections with mating threads for ease of assembly, one of the sections being a mandrel jacking section adapted to engage a shoulder with components positioned along the outer surface of the inner mandrel, the mating threads for the mandrel jacking section having sufficient travel that the mandrel jacking section serves as a screw jack during disassembly to exert a jacking force upon components which have become stuck to the outer surface of the inner mandrel.

10. The down hole bearing assembly as defined in claim 4, wherein the inner mandrel has a motor connection adapted for threaded connection to a down hole motor assembly, a deformable overload protection ring being included in the make up of the motor connection, the deformable overload protection ring being made from a material that has a yield strength that is lower than that of the inner mandrel, such that the deformable overload protection ring deforms to buffer the inner mandrel when momentary overload torque transmitted through the motor connection.

11. A down hole bearing assembly, comprising:
an outer housing with an inner surface defining an interior bore;
an inner mandrel supported for rotation within the interior bore of the outer housing, the inner mandrel having an outer surface and a motor connection adapted for threaded connection to a down hole motor assembly;
a deformable overload protection ring being included in the make up of the motor connection, the deformable overload protection ring being made from a material that has a yield strength that is lower than that of the inner mandrel, such that the deformable overload protection ring defonns to buffer the inner mandrel when momentary overload torque is transmitted through the motor connection.

12. A down hole bearing assembly, comprising:
an outer housing with an inner surface defining an interior bore;
an inner mandrel supported for rotation within the interior bore of the outer housing, the inner mandrel having an outer surface;
components positioned between the inner surface of the outer housing and the outer surface of the inner mandrel;
the inner mandrel being made in several sections with mating threads for ease of assembly, one of the sections being a mandrel jacking section adapted to engage a shoulder with those components positioned along the outer surface of the inner mandrel, the mating threads for the mandrel jacking section having sufficient travel that the mandrel jacking section serves as a screw jack during disassembly to exert a jacking force upon those components which have become stuck to the outer surface of the inner mandrel.

13. A down hole bearing assembly, comprising:
an outer housing with an inner surface defining an interior bore;
an inner mandrel supported for rotation within the interior bore of the outer housing, the inner mandrel having an outer surface;
components positioned between the inner surface of the outer housing and the outer surface of the inner mandrel;
the outer housing being made in several sections with mating threads for ease of assembly, the sections serving as a housing jacking section having a first shoulder that engages a first engagement shoulder of the mandrel at the first end and a second engagement shoulder that engages components positioned along the inner surface of the outer housing a the second end, the mating threads for the housing jacking section having sufficient travel that the housing jacking section exerts a jacking force upon components which have become stuck to the inner surface of the outer housing.

14. A down hole bearing assembly, comprising:
an outer housing with an inner surface defining an interior bore;
an inner mandrel supported for rotation within the interior bore of the outer housing, the inner mandrel having an outer surface;
a sealed and lubricant filled bearing chamber formed between the inner surface of the outer housing and the outer surface of the inner mandrel, the bearing chamber having a first end and a second end, a stationary seal being positioned at the second end, a floating seal piston at the first end, the floating seal piston having a lubrication face acting against lubricant in the bearing chamber and a drilling fluid face against which drilling fluid acts, a preload spring being provided which acts against the drilling fluid face;
a flow port is positioned upstream of the drilling fluid face of the floating seal piston, such that drilling fluid must pass through the flow port prior to acting against the drilling fluid face of the floating seal piston; and
a bearing stack of thrust bearings positioned in the bearing chamber.
